(19) United States
(12) Patent Application Publication
(10) Pub. No.: US 2009/0326951 A1
(43) Pub. Date: Dec. 31, 2009

(54) SPEECH SYNTHESIZING APPARATUS AND METHOD THEREOF

(75) Inventors: Ryo Morinaka, Tokyo (JP); Takehiko Kagoshima, Yokohama (JP)

Correspondence Address: TUROCY & WATSON, LLP, 127 Public Square, 57th Floor, Key Tower, CLEVELAND, OH, 44114, US

(73) Assignee: KABUSHIKI KAISHA TOSHIBA, Tokyo (JP)

(21) Appl. No.: 12/423,233

(22) Filed: Apr. 14, 2009

(30) Foreign Application Priority Data
Jun. 30, 2008 (JP) 2008-170044

(51) Int. Cl. G10L 13/06; G10L 13/00; G10L 11/04

(52) U.S. Cl. 704/268; 704/207; 704/260; 704/E13.009; 704/E13.011; 704/E11.006

(57) ABSTRACT

Ratios of powers at the peaks of respective formants of the spectrum of a pitch-cycle waveform and powers at boundaries between the formants are obtained and, when the ratios are large, bandwidth of window functions are widened and the formant waveforms are generated by multiplying generated sinusoidal waveforms from the formant parameter sets on the basis of pitch-cycle waveform generating data by the window functions of the widened bandwidth, whereby a pitch-cycle waveform is generated by the sum of these formant waveforms.

### CROSS REFERENCE TO RELATED APPLICATION

This application is based upon and claims the benefit of priority from the prior Japanese Patent Application No. 2008-170044, filed on Jun. 30, 2008; the entire contents of which are incorporated herein by reference.

### FIELD OF THE INVENTION

The present invention relates to a text-to-speech synthesis and, more specifically, to a speech synthesizing apparatus which generates speech signals from information such as phoneme sequence, pitches, phoneme duration and a method thereof.

### DESCRIPTION OF THE BACKGROUND

To generate the speech signals artificially from an arbitrary sentence is referred to as “text-to-speech synthesis”. The text-to-speech synthesis generally includes three units of a language processing unit, a prosody processing unit, and a speech signal synthesizing unit.

An input text is subjected to morphological analysis and syntactic analysis in the language processing unit as a first step, and then to processing of accents and intonations in the prosody processing unit as a second step, and phoneme sequence or prosodic information (fundamental frequency, phoneme duration, power, and so on) are outputted. Subsequently, the speech signals are synthesized from the phoneme sequence and the prosodic information in the speech signal synthesizing unit as a last step to realize the text-to-speech synthesis.

A principle of the speech synthesizing apparatus which is able to achieve the synthesis of the arbitrary phoneme sequence is to synthesize speech by storing underlying characteristic parameters in small speech unit (speech fragments) of CV, CVC, VCV, where V represents a vowel and C represents a consonant and connecting the same while controlling the pitch and the duration. In this method, the quality of synthesized speech depends on the stored speech fragments.

In such the speech synthesizing apparatus, a method of expressing the stored speech fragments using formant frequencies, and so on exists as a method of generating the speech fragments of good quality (see Japanese Patent No. 3732793). This method expresses a waveform which represents one formant (hereinafter, referred to as “formant waveform”) by multiplying a sinusoidal waveform having a formant frequency as its frequency by a window function, and an entire waveform is expressed by adding the respective formant waveforms.

Generating the speech fragments using such a method provides an advantage such that a flexible control such as changing the speech quality is enabled since parameters which directly relate to the phonemes or the speech quality can be controlled.

However, in the speech synthesizing method as disclosed in Japanese Patent No. 3732793, a spectrum of a pitch-cycle waveform generated using the parameters such as the formant frequencies and the window functions of the respective formants has a problem such that troughs between formants in the spectrum are deep, which results in deterioration of the sound quality of the synthesized speech.

### BRIEF SUMMARY OF THE INVENTION

In order to solve the problem described above, it is an object of the invention to provide a speech synthesizing apparatus which is able to generate synthesized speeches which are more natural and have a high sound quality and a method thereof.

According to embodiments of the invention, there is provided a speech synthesizing apparatus configured to generate speech signals by overlapping pitch-cycle waveforms according to pitch period, including: a storage unit configured to store a plurality of formant parameter sets each including at least a formant frequency, a formant phase, and a window function, the spectrum of which indicates the shape of the formant; a selecting unit configured to select the formant parameter set for one frame corresponding to a pitch mark from the storage on the basis of pitch-cycle waveform generating information for generating the pitch-cycle waveforms; a sinusoidal waveform generating unit configured to generate a sinusoidal waveform according to the formant frequency and the formant phase included in the formant parameter set for each of the formant parameter sets; a first formant waveform generating unit configured to generate a first formant waveform by multiplying the sinusoidal waveform by the window function included in the formant parameter set for each of the formant parameter sets;.a first pitch-cycle waveform generating unit configured to generate a first pitch-cycle waveform by the sum of the first formant waveforms; a data calculating unit configured to obtain ratios of a power at a peak of each formant in the spectrum of the first pitch-cycle waveform with respect to powers at boundaries of the each formant and adjacent formants; a bandwidth expanding and compressing unit configured to expand bandwidth of the window functions of the formants corresponding to the respective formants when the ratios are larger than a first threshold value; a second formant waveform generating unit configured to generate a second formant waveform by multiplying the sinusoidal waveform by the window function of the expanded bandwidth for each of the formant parameter sets; and a second pitch-cycle waveform generating unit configured to generate a second pitch-cycle waveform by the sum of the second formant waveforms.

According to embodiments of the invention, there is provided a speech synthesizing apparatus configured to generate speech signals by overlapping pitch-cycle waveforms according to pitch period, including: a storage unit configured to store a plurality of formant parameter sets each including at least a formant frequency, a formant phase, and a window function, the spectrum of which indicates the shape of the formant; a selecting unit configured to select the formant parameter set for one frame corresponding to pitch marks from the storage on the basis of pitch-cycle waveform generating data for generating the pitch-cycle waveforms; a sinusoidal waveform generating unit configured to generate a sinusoidal waveform according to the formant frequency and the formant phase included in the formant parameter set for each of the formant parameter sets; a first formant waveform generating unit configured to generate a first formant waveform by multiplying the sinusoidal waveform by the window function included in the formant parameter set for each of the formant parameter sets; a first pitch-cycle waveform generating unit configured to generate a first pitch-cycle waveform by the sum of the first formant waveforms; a data calculating unit configured to obtain bandwidth of the respective formants in the spectrum of the first pitch-cycle waveform; a bandwidth expanding and compressing unit configured to expand bandwidth of the window functions of the formants corresponding to the respective formants when bandwidth of the respective formants are narrow; a second formant waveform generating unit configured to generate a second formant waveform by multiplying the sinusoidal waveform by the window function of the expanded bandwidth for each of the formant parameter sets; and a second pitch-cycle waveform generating unit configured to generate a second pitch-cycle waveform by the sum of the second formant waveforms.

According to embodiments of the invention, there is provided a speech synthesizing apparatus configured to generate speech signals by overlapping pitch-cycle waveforms according to pitch period, including: a storage unit configured to store a plurality of formant parameter sets each including at least a formant frequency, a formant phase, and a window function, the spectrum of which indicates the shape of the formant; a selecting unit configured to select the formant parameter set for one frame corresponding to pitch marks from the storage on the basis of a pitch-cycle waveform generating data for generating the pitch-cycle waveforms;

a sinusoidal waveform generating unit configured to generate a sinusoidal waveform according to the formant frequency and the formant phase included in the formant parameter set for each of the formant parameter sets; a first formant waveform generating unit configured to generate a first formant waveform by multiplying the generated sinusoidal waveform by the window function included in the formant parameter set for each of the formant parameter sets; a first pitch-cycle waveform generating unit configured to generate a first pitch-cycle waveform by the sum of the first formant waveforms; a data calculating unit configured to obtain frequency distances of the respective formants in the spectrum of the first pitch-cycle waveform; a bandwidth expanding and compressing unit configured to expand bandwidth of the window functions of the formants corresponding to the respective formants when the frequency distances are large; a second formant waveform generating unit configured to generate a second formant waveform by multiplying the sinusoidal waveform by the window function of the expanded and compressed bandwidth for each of the formant parameter sets; and a second pitch-cycle waveform generating unit configured to generate a second pitch-cycle waveform by the sum of the second formant waveforms.

According to the embodiments of the invention, since the undulation of the spectrum of the pitch-cycle waveform to be generated is flexibly controlled, so that generation of synthesized speeches which are more natural and have a high sound quality is enabled.

### BRIEF DESCRIPTION OF THE DRAWINGS

FIG. 1 is a block diagram showing a configuration of a speech synthesizing apparatus according to a first embodiment of the invention;

FIG. 2 is a schematic diagram showing generation of a voiced speech by overlapping pitch-cycle waveforms;

FIG. 3 is a block diagram of a pitch-cycle waveform generating unit according to the first embodiment of the invention;

FIG. 4 is a schematic diagram showing an example of formant parameters;

FIG. 5 is a flowchart of processing in a bandwidth expanding and compressing unit;

FIG. 6 is a flowchart showing processing in a data calculating unit;

FIG. 7 is a schematic diagram showing an example of troughs between extracted formants in a power spectrum;

FIG. 8 is a schematic diagram showing examples of sinusoidal waveforms, window functions, formant waveforms, and a pitch-cycle waveform;

FIG. 9 is a schematic diagram showing an example of power spectrums of the sinusoidal waveforms, the window functions, the formant waveforms, and the pitch-cycle waveforms;

FIG. 10 is a flowchart showing the processing in the data calculating unit according to a second embodiment of the invention;

FIG. 11 is a schematic diagram showing an example of the formant parameter according to the second embodiment; and

FIG. 12 is a block diagram of the pitch-cycle waveform generating unit according to the second embodiment of the invention.

### DETAILED DESCRIPTION OF THE INVENTION

Referring now to the schematic diagrams, a speech synthesizing apparatus which realizes a text-to-speech synthesizing method according to an embodiment of the invention will be described.

### First Embodiment

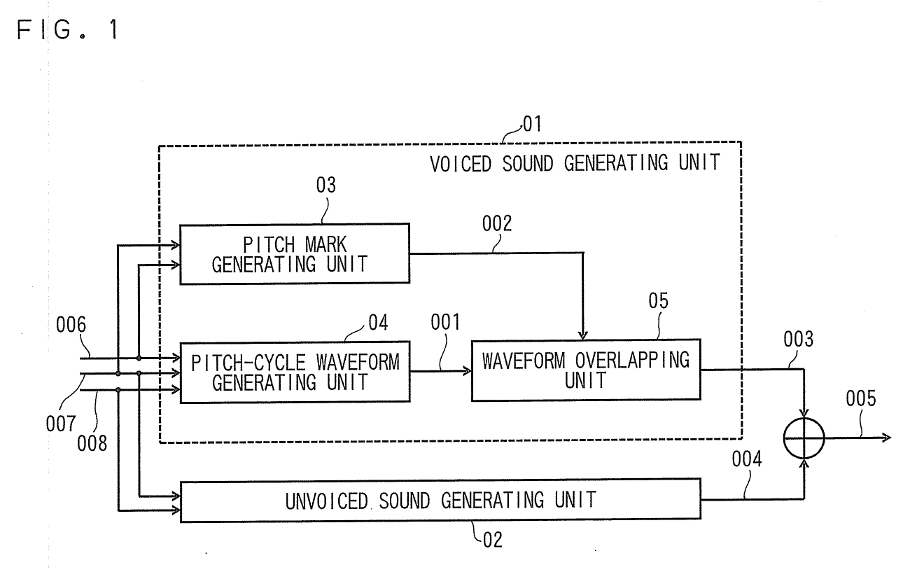

Referring now to FIGS. 1 to 9, a speech synthesizing apparatus according to a first embodiment of the invention will be described. FIG. 1 is a block diagram showing a configuration of the speech synthesizing apparatus according to the first embodiment.

The speech synthesizing apparatus receives entries of pitch patterns 006, phoneme duration 007, and phoneme sequence 008, and outputs synthetic speech signals 005. The speech synthesizing apparatus includes a unvoiced sound generating unit 02 and a voiced sound generating unit 01, and generates the synthetic speech signals 005 by adding unvoiced speech signals 004 and voiced speech signals 003 outputted respectively there from.

The respective functions of the unvoiced sound generating unit 02 and the voiced sound generating unit 01 may be implemented by a program transmitted to or stored in a computer.

The unvoiced sound generating unit 02 refers to the phoneme duration 007 and the phoneme sequence 008, and generates the unvoiced speech signals 004 mainly when the corresponding phoneme is an unvoiced consonant or a voiced friction sound. The unvoiced sound generating unit 02 may be realized by known technology such as a method of driving a LPC synthesizing filter by a white noise.

The voiced sound generating unit 01 includes a pitch mark generating unit 03, a pitch-cycle waveform generating unit 04, and a waveform overlapping unit 05.

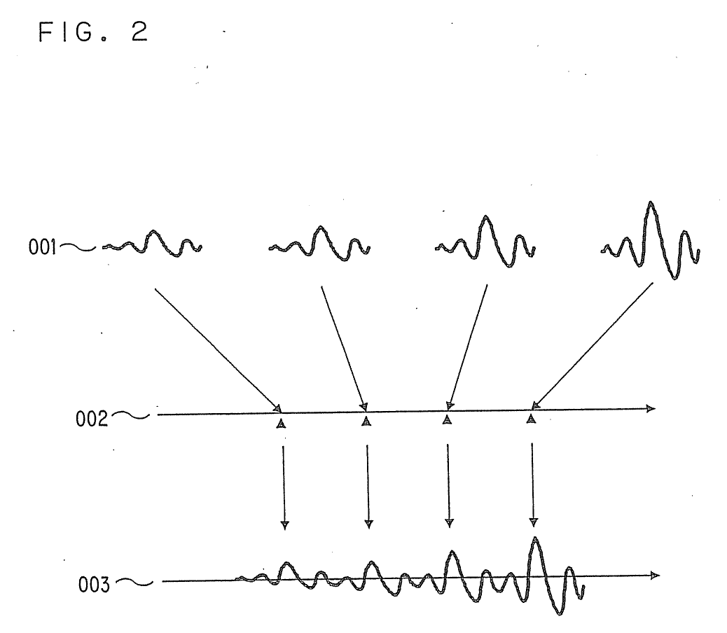

The pitch mark generating unit 03 refers to the pitch pattern 006 and the phoneme duration 007 as pitch-cycle waveform generating information, and generates pitch marks 002 as shown in FIG. 2. The pitch marks 002 indicate positions where pitch-cycle waveforms 001 are to be overlapped, and the spacing of the pitch marks corresponds to the pitch period.

The pitch-cycle waveform generating unit 04 refers to the pitch patterns 006, the phoneme duration 007, and the phoneme sequence 008, and generates the pitch-cycle waveforms 001 which correspond respectively to the pitch marks 002 as shown in FIG. 2.

The waveform overlapping unit 05 overlaps the corresponding pitch-cycle waveforms 001 to the positions indicated by the pitch marks 002 to generate the voiced speech signals 003.

Subsequently, the configuration of the pitch-cycle waveform generating unit 04 shown in FIG. 1 will be described in detail.

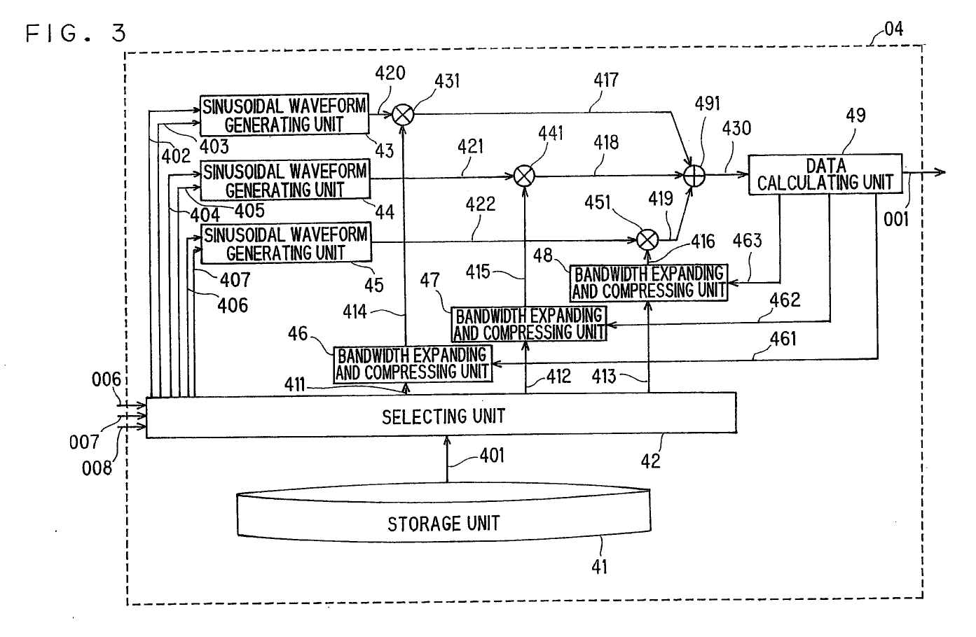

FIG. 3 is a block diagram showing the configuration of the pitch-cycle waveform generating unit 04 in the first embodiment. The pitch-cycle waveform generating unit 04 includes a storage unit 41, a selecting unit 42, sinusoidal waveform generating units 43, 44 and 45, bandwidth expanding and compressing units 46, 47, and 48, a data calculating unit 49, formant waveform generating units 431, 441, and 451, and a pitch-cycle waveform generating unit 491.

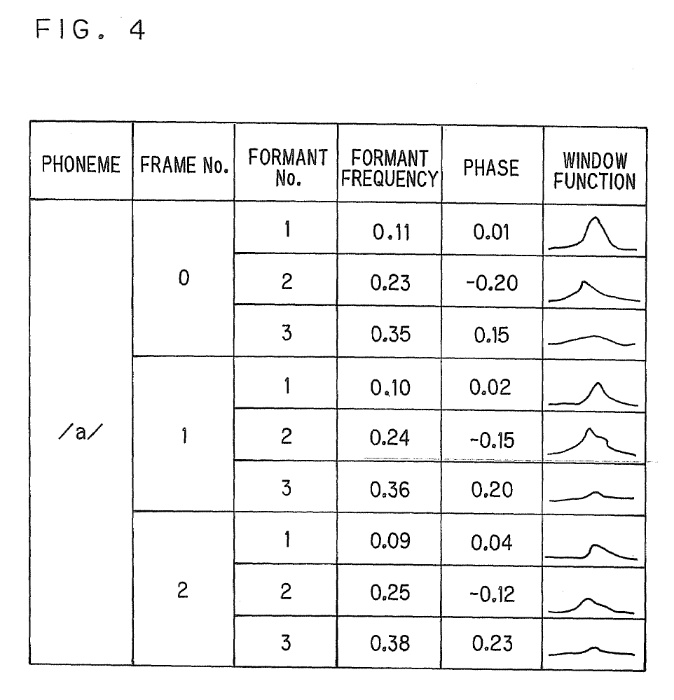

Formant parameters are stored in the storage unit 41 in the unit of speech fragment. FIG. 4 shows an example of the formant parameters of fragments of a phoneme /a/. In this example, the fragment of /a/ includes three frames, and each frame includes three formants. As the parameters which indicate characteristics of the respective formants, formant frequencies, formant phases, and window functions are stored. The term “window function” is a function whose spectrum itself indicates the shape of the formant.

The selecting unit 42 refers to the pitch patterns 006, the phoneme duration 007, and the phoneme sequence 008 as the pitch-cycle waveform generating information to be entered into the pitch-cycle waveform generating unit 04, and selects and reads out formant parameters 401 corresponding to one frame which corresponds to the pitch marks 002 from the storage unit 41.

The formant parameters 401 are outputted in such a manner that parameters corresponding to formant No. 1 are outputted as a formant frequency 402, a formant phase 403, and a window function 411 and, in the same manner, parameters corresponding to formant No. 2 are outputted as a formant frequency 404, a formant phase 405, and a window function 412, and parameters corresponding to formant No. 3 are outputted as a formant frequency 406, a formant phase 407, and a window function 413.

The sinusoidal waveform generating unit 43 outputs a sinusoidal waveform 420 according to the formant frequency 402 and the formant phase 403.

The bandwidth expanding and compressing unit 46 expands and compresses the window functions 411 read from the storage unit 41 according to bandwidth expanded and compressed signals 461, and outputs bandwidth expanding and compressing window functions 414.

The formant waveform generating units 431, 441, and 451 have the following two functions. The first function is a function as a first formant waveform generating unit which windows the sinusoidal waveform by the window function in a state of not being expanded and compressed in the bandwidth expanding and compressing units 46, 47, and 48 to generate formant waveforms. The second function is a function as a second formant waveform generating unit which windows the sinusoidal waveform by bandwidth expanded and compressed window functions outputted from the bandwidth expanding and compressing units 46, 47, and 48 to generate formant waveforms.

The pitch-cycle waveform generating unit 491 has the following two functions. The first function is a function as a first pitch-cycle waveform generating unit which generates a pitch-cycle waveform 430 by adding formant waveforms 417, 418, and 419 generated by windowing with the window functions in the state of not being expanded and compressed respectively. The second function is a function as a second pitch-cycle waveform generating unit which generates the pitch-cycle waveform 430 by adding the formant waveforms 417, 418, and 419 generated by windowing with the expanded and compressed window functions respectively.

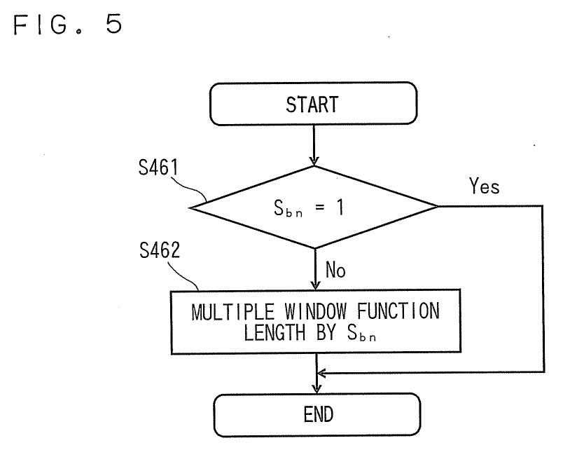

FIG. 5 is a flowchart of processing in the bandwidth expanding and compressing unit 46. The value of bandwidth expanded and compressed signal with respect to a formant having the formant No. n is represented by s_{bn}.

In Step S461, when s_{bn}=1 is satisfied, a window function read out from the storage unit 41 is outputted as bandwidth expanded and compressed signal (Yes in Step S461).

In Step S461, when the vale of s_{bn} is not 1, the window function length is multiplied by s_{bn} in Step S462. Changing the window function length is achieved by technologies in the related art such as increasing the time resolution of the window function using a spline interpolation, and then carrying out sampling at desired intervals. The bandwidth expanded and compressed window function which is expanded and compressed in bandwidth is outputted.

The formant waveform generating unit 431 windows the sinusoidal waveform 420 by the bandwidth expanded and compressed window function 414 outputted from the bandwidth expanding and compressing unit 46, and generates the formant waveform 417. The formant waveform y(t) is expressed by Expression (1) shown below;

y(t)=w(t)·cos(ωt+φ) (1)

where ω represents the formant frequency 402, φ represents the formant phase 403, and w(t) represents the bandwidth expanded and compressed window function 414 outputted from the bandwidth expanding and compressing unit 46.

In the same manner, the sinusoidal waveform generating unit 44 outputs a sinusoidal waveform 421 according to the formant frequency 404 and the formant phase 405. The formant waveform generating unit 441 windows the sinusoidal waveform 421 by a bandwidth expanded and compressed window function 415 outputted from the bandwidth expanding and compressing unit 47, and generates the formant waveform 418.

The sinusoidal waveform generating unit 45 outputs sinusoidal waveform 422 according to the formant frequency 406 and the formant phase 407. The formant waveform generating unit 451 windows the sinusoidal waveform 421 by a bandwidth expanded and compressed window function 416 outputted from the bandwidth expanding and compressing unit 48, and generates the formant waveform 419.

The pitch-cycle waveform generating unit 491 adds the formant waveforms 417, 418, and 419 respectively to generate the pitch-cycle waveform 430.

The data calculating unit 49 calculates a spectrum envelope of the pitch-cycle waveforms and calculates the bandwidth expanded and compressed signals for the respective formants from the calculated spectrum envelope.

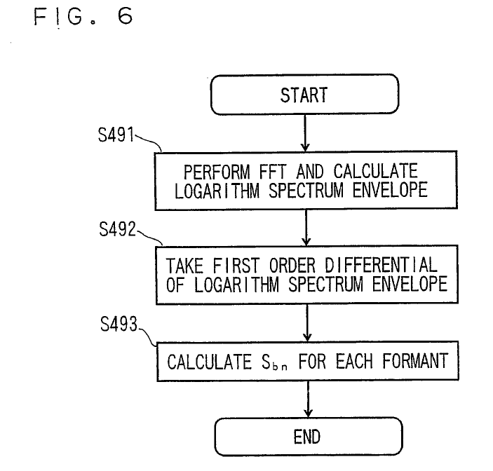

FIG. 6 is a flowchart showing processing in the data calculating unit 49.

In Step S491, FFT (Fast Fourier Transform) is carried out on the pitch-cycle waveform 430, and then a logarithm spectrum envelope of the pitch-cycle waveforms is calculated.

Then, in Step S492, a first order differential of the logarithm spectrum envelope is taken. By taking the first order differential of the logarithm spectrum envelope, crests of the logarithm spectrum envelope (substantially located at positions of the formant frequencies, which correspond to peaks of the formants) and troughs (boundaries between adjacent formants) are calculated, and the positions of the crest, the position of the trough in the low-frequency direction, and the position of the trough in the high-frequency direction for one formant are calculated.

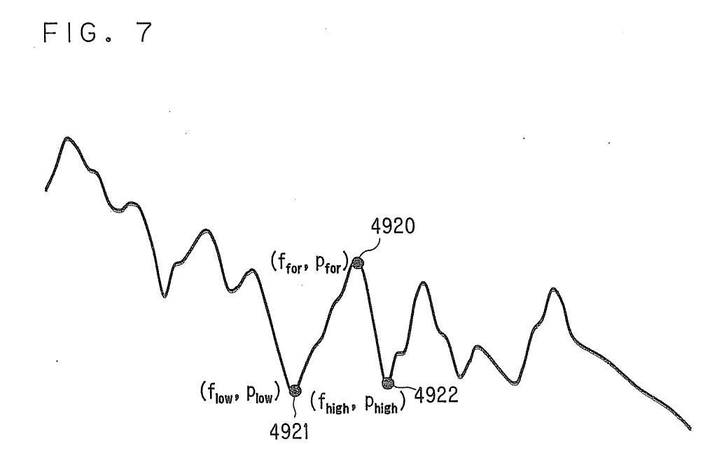

Focusing on a certain formant, the relation among the formant frequency f_{for} and the power P_{for} of the formant frequency at a crest 4920, the frequency f_{low} and the power p_{low} at a trough 4921 in the low-frequency direction, and the frequency f_{high} and the power p_{high} at a trough 4922 in the high-frequency direction are shown in FIG. 7.

Finally, in Step S493, the bandwidth expanded and compressed signals are calculated for the respective formants from the first ratios H1 between the power P_{for} of the crest of the calculated logarithm spectrum envelope and the power p_{low} of the trough in the low-frequency direction, and a second ratio H2 between the power P_{for} of the crest of the spectrum envelope and the power p_{high} of the though in the high-frequency direction. The first ratio and the second ratio are obtained for each formant.

For example, when the first ratio H1 and the second ratio H2 are both larger than a threshold value S, a first bandwidth expanded and compressed signal s_{bn1} (where s_{bn1}>1) which expands the bandwidth of the window function is calculated. When the bandwidth of the window function is expanded by the first bandwidth expanded and compressed signal s_{bn1}, the depth of the trough between the formant is reduced.

When one of the first ratio H1 and the second ratio H2 is larger than a threshold value S1, a second bandwidth expanded and compressed signal s_{bn2} (where s_{bn1}>s_{bn2}>1) which expands the bandwidth of the window function is calculated. Accordingly, although the amount of reduction of the depth is smaller than the case of the first bandwidth expanded and compressed signal s_{bn1}, the depth of the trough between the formants may be reduced.

Furthermore, when the first ratio H1 and the second ratio H2 are both smaller than the threshold value S, expanding or compression of the bandwidth of the window function is not carried out. The value of the bandwidth expanded and compressed signal is determined as s_{bn}=1.

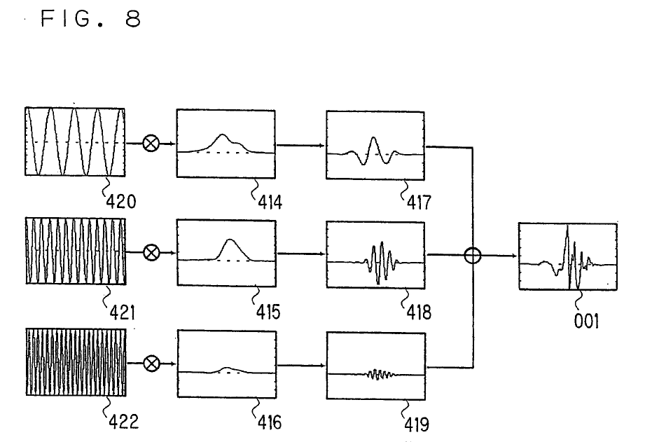

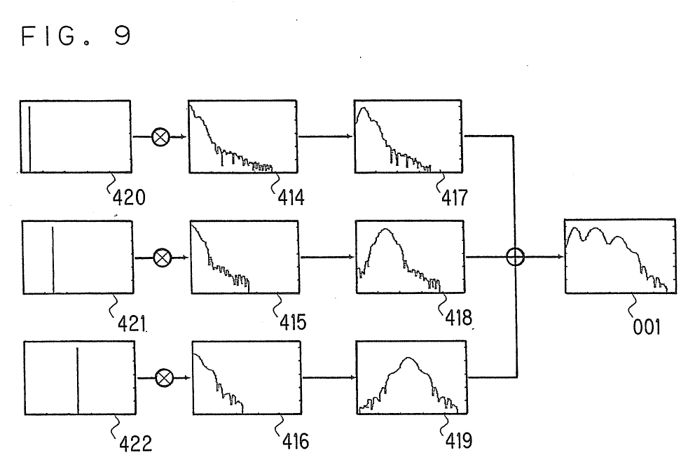

Examples of the sinusoidal waveforms generated from the formant frequency and the formant phase, the expanded or compressed window functions, the formant waveforms, and the pitch-cycle waveform are shown in FIG. 8. Power spectrums of these waveforms are shown in FIG. 9. In FIG. 8, the horizontal axis represents the time, and the vertical axis indicates the amplitude, and in FIG. 9, the horizontal axis represents the frequency, and the vertical axis represents the amplitude.

The sinusoidal waveforms 420, 421, and 422 shown in FIG. 8 become line spectrums 420, 421, and 422 having a sharp peak as shown in FIG. 9, and the expanded or compressed window functions 414, 415, and 416 become spectrums 414, 415, and 416 concentrated in the low frequency as shown in FIG. 9.

The windowing (multiplying) in the time domain corresponds to the convolution in the frequency domain. Therefore, spectrum 417, 418, and 419 of the formant waveforms have shapes obtained by translating the spectrum 414, 415, and 416 of the expanded and compressed window functions to the positions of the sinusoidal waveform frequencies 420, 421, and 422.

Therefore, by controlling the frequency and the phase of the sinusoidal waveforms, the center frequency or the phase of the formants of the pitch-cycle waveform can be changed, and by controlling the shapes of the window functions, the shape of the spectrums of the formants of the pitch-cycle waveform can be changed.

The method of expansion and compression of the window function will be described in further detail.

First of all, a sinusoidal waveform corresponding to one pitch-cycle waveform is outputted from the sinusoidal waveform generating unit 43, and a formant waveform is generated with a window function which is not expanded and compressed in the bandwidth expanding and compressing unit 46 in a first stage. The same process is carried out for other sinusoidal waveform generating units 44 and 45. Then, a synthesized first pitch-cycle waveform 001 is generated. The first pitch-cycle waveform 001 is not outputted to the outside.

Then, the data calculating unit 49 calculates the bandwidth expanded and compressed signals by the method described above on the basis of the synthesized first pitch-cycle waveform 001. Subsequently, the bandwidth expanding and compressing unit 46 expands or compresses the window functions on the basis of the bandwidth expanded and compressed signals, and convolutes the sinusoidal waveform outputted from the corresponding sinusoidal waveform generating unit 43 by the expanded or compressed bandwidth expanded and compressed window function to calculate the formant waveform. The same process is carried out for other bandwidth expanding and compressing units 47 and 48. Then, the pitch-cycle waveform 001 is synthesized again, and the synthesized second pitch-cycle waveform 001 is outputted. In other words, the bandwidth expansion or compression of the window function is carried out once and the pitch-cycle waveform is outputted.

In other words, since the bandwidth expanded and compressed signals cannot be calculated in an initial state at the beginning, the formant functions are generated with the window functions which are not expanded and compressed once for the meanwhile, and then the bandwidth expanded and compressed signals are calculated on the basis thereof. Here, the sinusoidal waveform used at the beginning and the sinusoidal waveform used for the second time is the same sinusoidal waveform, which corresponds to one formant waveform.

The expansion and compression of the bandwidth of the window function is carried out only once in the embodiment shown above, the invention is not limited thereto, and a pitch-cycle waveform obtained by a window function subjected to twice or more expansion or compression may be outputted.

The first embodiment has the following effects for the speech synthesizing method in the related art (for example, see Japanese Patent No. 3732793).

The pitch-cycle waveform generating unit 04 shown in FIG. 1 according to the first embodiment is different from the speech synthesizing method in the related art in that the data calculating unit 49 calculates the spectrum data of the pitch-cycle waveform which is generated once, and expands or compresses the band width of the window function of part of or the every formant on the basis of the calculated spectrum data.

In the first embodiment, a flexible control of undulations in spectrum of the pitch-cycle waveforms which cannot be achieved in the speech synthesizing method in the related art is enabled, so that generation of synthesized speeches which are more natural and have a high sound quality is enabled.

In other words, the ratios of the power of the crest with respect to the power of the trough in the low-frequency direction and the power of the trough in the high-frequency direction are obtained for one formant, and if the ratios are large, it is determined that the depth of the trough is large, and the depth of the portion of the trough of the spectrum between the formants is reduced, whereby the synthesized speech is not deteriorated.

In the first embodiment described above, the ratios of the power of the crest with respect to the power of the trough in the low-frequency direction and the power of the trough in the high-frequency direction are obtained and, when the ratios are larger than the threshold value, the bandwidth of the window function is expanded to reduce the depth of the troughs. However, the speech might be deteriorated also when the depths of the troughs are small and the modulations are not enough as well on the contrary. Therefore, in addition to the determination where the ratios are larger than the threshold value, when the ratios are smaller than the threshold valve, it may be determined that there is no trough and no rise and fall in the voice, and the depth of the trough between the formants may be increased to prevent deterioration of the synthesized speech.

### Second Embodiment

In the first embodiment, the spectrum data is calculated by using the ratios of the power of the crest with respect to the power of the trough in the low-frequency direction and the power of the trough in the high-frequency direction for the one formant. However, the invention is not limited thereto.

Referring now to FIG. 7, the speech synthesizing apparatus according to a second embodiment of the invention will be described.

The data calculating unit 49 according to the second embodiment will be described.

The data calculating unit 49 calculates the bandwidth per formant by recognizing the frequency distance between the troughs obtained by taking a first order differential of the spectrum envelope as the “bandwidth of the formant”.

In FIG. 7, the difference between the frequency f_{low} at the trough 4921 in the low-frequency direction and the frequency f_{high} at the trough 4922 in the high-frequency direction corresponds to the bandwidth. At this time, since it is assumed that the lower the frequency of the formant is, the narrower the bandwidth becomes, the bandwidth per formant can be calculated by applying frequency warping (for example, to convert into a mel-scale) such that the lower the frequency is, the higher the resolution becomes.

The bandwidth expanded and compressed signals are calculated using the bandwidth calculated per formant. In this case, when the bandwidth of the formant calculated from the trough in the low-frequency direction and the trough in the high-frequency direction for one formant is narrow, it is determined that the depth of the trough is large and the bandwidth is increased, and the bandwidth expanded and compressed signals which reduce the depths of the portions between the formants are calculated.

Whether the bandwidth of the formant is wide or narrow is determined by providing a threshold value. Accordingly, in the second embodiment, the formants having a desired bandwidth are generated in comparison with the first embodiment, and the highly flexible control of the spectrum envelope is enabled, so that generation of synthesized speeches which are more natural and have a high sound quality is enabled.

In other words, by obtaining the bandwidth of the formant calculated from the trough in the low-frequency direction and the trough in the high-frequency direction, determining that the depth of the trough is large when the bandwidth is narrower than the threshold value, and reducing the depth of the portion of the trough of the spectrum between the formants by widening the bandwidth, deterioration of the synthesized speeches is prevented.

### Modifications

In the second embodiment, the bandwidth of the formant is obtained and, when the bandwidth is narrow, the bandwidth of the window function is expanded to reduce the depth of the trough. However, the speech might be deteriorated also when the depths of the troughs are small and the undulations are not enough on the contrary. Therefore, in addition to the determination where the bandwidth is narrower than the threshold value, when the bandwidth is wider than the threshold value, it may be determined that there is no trough and no rise and fall in the voice, and the depth of the trough of the spectrum between the formants may be increased to prevent deterioration of the synthesized speech.

### Third Embodiment

The bandwidth expanded and compressed signals are calculated by using the ratios of the power of the crest with respect to the power of the trough in the low-frequency direction and the power of the trough in the high-frequency direction for the one formant in the first embodiment and by using the bandwidth of the formant calculated from the trough in the low-frequency direction and the trough in the high-frequency direction for one formant in the second embodiment. However, the invention is not limited thereto.

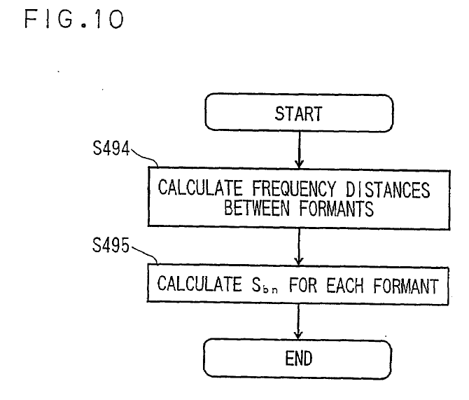

Referring now to FIG. 10, the speech synthesizing apparatus according to a third embodiment will be described.

The data calculating unit 49 according to the third embodiment will be described.

The data calculating unit 49 obtains the frequency distance using the formant frequency retained as the formant parameter and the formant frequencies retained by the formant parameters of the adjacent formants.

At this time, since it is assumed that the lower the frequency of the formant is, the narrower the bandwidth becomes, the bandwidth per formant can be calculated by applying the frequency warping (for example, to convert into a mel-scale) such that the lower the frequency is, the higher the resolution becomes.

FIG. 10 is a flowchart showing the processing in the data calculating unit 49.

First of all, in Step S494, the frequency distances between the respective formants are calculated using the formant frequencies of the formant parameter.

Subsequently, the bandwidth expanded and compressed signals are calculated according to the frequency distances calculated in Step S495. In this case, when the frequency distance between the formant frequencies is longer than the threshold value, it is determined that the depth of the trough is large and the bandwidth is widened, and the bandwidth expanded and compressed signals which reduce the depth of the portions of the trough of the spectrum between the formants are calculated.

Whether the frequency distance is large or small is determined by providing a threshold value.

Accordingly, in the third embodiment, increase in amount of calculation due to the execution of FFT is restrained in comparison with the first embodiment and the second embodiment and, consequently, highly flexible control of the spectrum envelope is enabled by the small amount of calculation.

In other words, by obtaining the frequency distances between the formant frequencies, determining that the depth of the trough is large when the frequency distance is larger than the threshold value, and reducing the portion of the trough of the spectrum between the formants by widening the bandwidth, deterioration of the synthesized speeches is prevented.

In the third embodiment, the frequency distances between the formant frequencies are obtained and, when the frequency distances are small, the bandwidth of the window function is expanded to reduce the depth of the troughs. However, the speech might be deteriorated also when the depths of the troughs are small and the undulations are not enough on the contrary. Therefore, in addition to the determination where the frequency distance is smaller than the threshold value, when the frequency distance is larger than the threshold value, it may be determined that there is no trough and no rise and fall in the voice, and the depth of the trough of the spectrum between the formants may be increased to prevent deterioration of the synthesized speech.

### Fourth Embodiment

The window functions are stored as the formant parameter in the first, second, and third embodiments. However, the invention is not limited thereto.

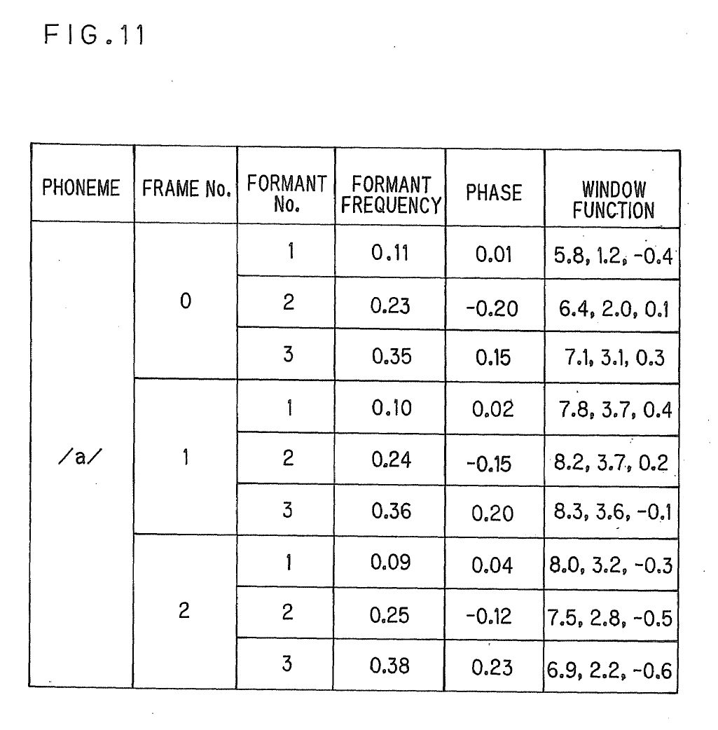

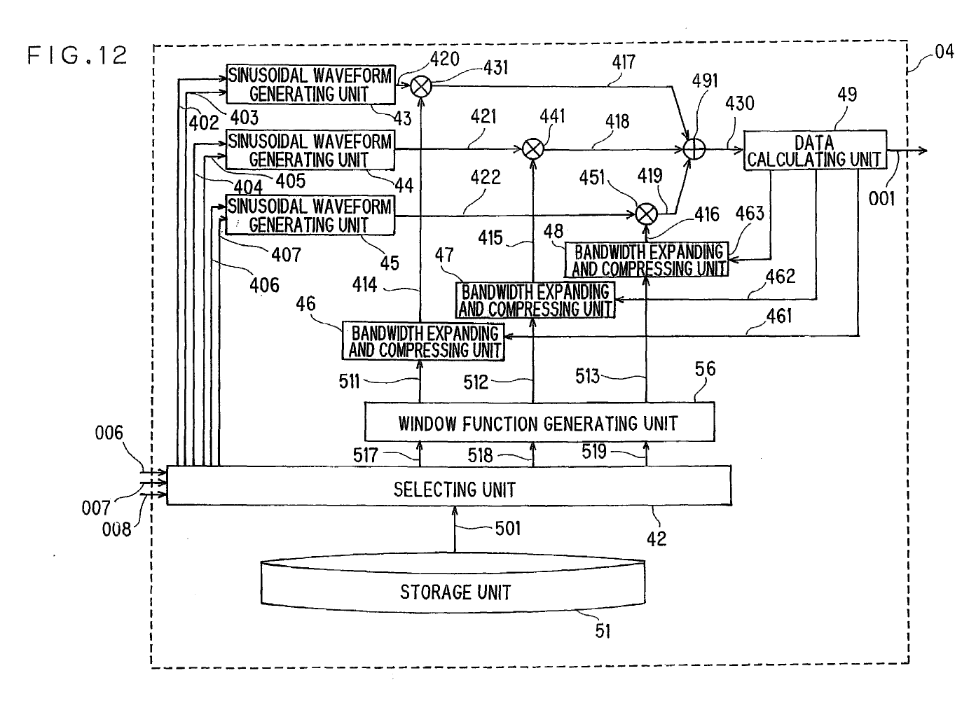

Referring now to FIGS. 11 to 12, the speech synthesizing apparatus according to a fourth embodiment of the invention will be described.

Weighted coefficients of the window functions expanded by the function are stored in the storage unit 51 as the formant parameter instead of the window functions.

FIG. 11 shows an example of the formant parameter stored in a storage unit 51 according to the fourth embodiment.

In this example, the window functions are expanded into weighted sums of the three basis functions, and hence the three sets of coefficients are stored as weighted coefficient sets of the window function.

The pitch-cycle waveform generating unit 04 according to the fourth embodiment will be described.

FIG. 12 shows a block diagram of the pitch-cycle waveform generating unit 04.

Like numbers reference corresponding elements in FIG. 3, and the different points are mainly described. The formant frequencies 402, 404, and 406 and the formant phases 403, 405, and 407 selected by the parameter selecting unit 42 from among the parameters (the formant frequency, the formant phase, and the sets of weighted coefficients of the window functions) 501 are outputted to the sinusoidal waveform generating units 43, 44, and 45, and set of weighted coefficients 517, 518, and 519 of the window functions are outputted to a window function generating unit 56.

The window function generating unit 56 generates window functions 511, 512, and 513 according to the set of weighted coefficients 517, 518, and 519. The window function w(t) is expressed by the following Expression (2)

W(t)=a1·b1(t)+a2·b2(t)+a3·b3(t) (2)

where a1, a2, and a3 are the sets of the weighted coefficient of the window function, b1(t), b2(t), and b3(t) are basis function.

The basis to be used for the basis function expansion of the window function may be DCT basis or a basis obtained by KL expansion. In the fourth embodiment, the order of the basis is 3. However, the order can be set as desired. By applying the basis function expansion to the window function, an advantage such that the storage capacity of the formant parameter can be reduced is achieved.

The invention is not limited to the embodiments shown above as is, and components may be modified and embodied without departing from the scope of the invention in the stage of implementation. Various modes of the invention are achieved by combining the plurality of components disclosed in the embodiments described above as needed. For example, several components may be eliminated from all the components shown in the embodiment. In addition, the components in different embodiments may be combined as needed.

What is claimed is:

1. A speech synthesizing apparatus configured to generate speech signals by overlapping pitch-cycle waveforms according to pitch period, comprising:
a storage unit configured to store a plurality of formant parameter sets each including at least a formant frequency, a formant phase, and a window function the spectrum of which indicates the shape of the formant;
a selecting unit configured to select the formant parameter set for one frame corresponding to a pitch mark from the storage on the basis of pitch-cycle waveform generating data for generating the pitch-cycle waveforms;
a sinusoidal waveform generating unit configured to generate a sinusoidal waveform according to the formant frequency and the formant phase included in the formant parameter set for each of the formant parameter sets;
a first formant waveform generating unit configured to generate a first formant waveform by multiplying the sinusoidal waveform by the window function included in the formant parameter set for each of the formant parameter sets;
a first pitch-cycle waveform generating unit configured to generate a first pitch-cycle waveform by the sum of the first formant waveforms;
a data calculating unit configured to obtain ratios of a power at a peak of each formant in the spectrum in the first pitch-cycle waveform with respect to powers at boundaries of the each formant and adjacent formants;
a bandwidth expanding and compressing unit configured to expand bandwidth of the window functions of the formants corresponding to the respective formants when the ratios are larger than a first threshold value;
a second formant waveform generating unit configured to generate a second formant waveform by multiplying the sinusoidal waveform by the window function of the expanded bandwidth for each of the formant parameter sets; and
a second pitch-cycle waveform generating unit configured to generate a second pitch-cycle waveform by the sum of the second formant waveforms.

2. The apparatus according to claim 1, wherein the bandwidth expanding and compressing unit narrows the bandwidth of the window function when the ratios are smaller than a second threshold value, and the second formant waveform generating unit generates the second formant waveforms by multiplying the sinusoidal waveforms by the window functions of the narrowed bandwidth for the respective formant parameter sets.

3. A speech synthesizing apparatus configured to generate speech signals by overlapping pitch-cycle waveforms according to pitch period, comprising:
a storage unit configured to store a plurality of formant parameter sets each including at least a formant frequency, a formant phase, and a window function, the spectrum of which indicates the shape of the formant;
a selecting unit configured to select the formant parameter set for one frame corresponding to a pitch mark from the storage on the basis of pitch-cycle waveform generating data for generating the pitch-cycle waveforms;
a sinusoidal waveform generating unit configured to generate a sinusoidal waveform according to the formant frequency and the formant phase included in the formant parameter set for each of the formant parameter sets;
a first formant waveform generating unit configured to generate a first formant waveform by multiplying the sinusoidal waveform by the window function included in the formant parameter set for each of the formant parameter sets;
a first pitch-cycle waveform generating unit configured to generate a first pitch-cycle waveform by the sum of the first formant waveforms;
a data calculating unit configured to obtain bandwidth of the respective formants in the spectrum of the first pitch-cycle waveform;
a bandwidth expanding and compressing unit configured to expand bandwidth of the window functions of the formants corresponding to the respective formants when bandwidth of the respective formants is narrow;
a second formant waveform generating unit configured to generate a second formant waveform by multiplying the sinusoidal waveform by the window function of the expanded bandwidth for each of the formant parameter sets; and
a second pitch-cycle waveform generating unit configured to generate a second pitch-cycle waveform by the sum of the second formant waveforms.

4. The apparatus according to claim 3, wherein the bandwidth expanding and compressing unit narrows the bandwidth of the window functions of the formants corresponding to the respective formants when the bandwidth of the respective formant are wide, and the second formant waveform generating unit generates the second formant waveforms by multiplying the sinusoidal waveforms by the window functions of the narrowed bandwidth for the respective formant parameter sets.

5. A speech synthesizing apparatus configured to generate speech signals by overlapping pitch-cycle waveforms according to pitch period, comprising:
a storage unit configured to store a plurality of formant parameter sets each including at least a formant frequency, a formant phase, and a window function, the spectrum of which indicates the shape of the formant;
a selecting unit configured to select the formant parameter set for one frame corresponding to a pitch mark from the storage on the basis of pitch-cycle waveform generating data for generating the pitch-cycle waveforms;
a sinusoidal waveform generating unit configured to generate a sinusoidal waveform according to the formant frequency and the formant phase included in the formant parameter set for each of the formant parameter sets;
a first formant waveform generating unit configured to generate a first formant waveform by multiplying the generated sinusoidal waveform by the window function included in the formant parameter set for each of the formant parameter sets;
a first pitch-cycle waveform generating unit configured to generate a first pitch-cycle waveform by the sum of the first formant waveforms;
a data calculating unit configured to obtain frequency distances of the respective formants in the spectrum of the first pitch-cycle waveform;
a bandwidth expanding and compressing unit configured to expand bandwidth of the window functions corresponding to the respective formants when the frequency distances are large;
a second formant waveform generating unit configured to generate a second formant waveform by multiplying the sinusoidal waveform by the window function of the expanded and compressed bandwidth for each of the formant parameter sets; and
a second pitch-cycle waveform generating unit configured to generate a second pitch-cycle waveform by the sum of the second formant waveforms.

6. The apparatus according to claim 5, wherein the bandwidth expanding and compressing unit narrows the bandwidth when the frequency distances are short, and the second formant waveform generating unit generates the second formant waveforms by multiplying the sinusoidal waveforms by the window functions of the narrowed bandwidth for the respective formant parameter sets.

7. The apparatus according to claim 1, wherein the second formant waveform generating unit outputs the second formant waveforms.

8. The speech synthesizing apparatus according to claim 3, wherein the second formant waveform generating unit outputs the second formant waveforms.

9. The speech synthesizing apparatus according to claim 5, wherein the second formant waveform generating unit outputs the second formant waveforms.

10. The speech synthesizing apparatus according to claim 1, wherein the storage unit stores weighted coefficients of the window functions which are expanded by the basis function as the window functions.

11. The speech synthesizing apparatus according to claim 3, wherein the storage unit stores the weighted coefficients of the window functions which are expanded by the basis function as the window functions.

12. The speech synthesizing apparatus according to claim 5, wherein the storage unit stores the weighted coefficients of the window functions which are expanded by the basis function as the window functions.

13. A speech synthesizing method configured to generate speech signals by overlapping pitch-cycle waveforms according to pitch period, comprising steps of:
storing a plurality of formant parameter sets each including at least a formant frequency, a formant phase, and a window function, the spectrum of which indicates the shape of the formant in storage;
selecting the formant parameter set for one frame corresponding to pitch marks from the storage on the basis of pitch-cycle waveform generating data for generating the pitch-cycle waveforms;
generating a sinusoidal waveform according to the formant frequency and the formant phase included in the formant parameter set for each of the formant parameter sets;
generating a first formant waveform by multiplying the sinusoidal waveform by the window function included in the formant parameter set for each of the formant parameter sets;
generating a first pitch-cycle waveform by the sum of the first formant waveforms;
obtaining ratios of a power at the peak of each formant in a spectrum in the first pitch-cycle waveform with respect to powers at boundaries of the each formant and adjacent formants;
expanding bandwidth of the window functions of the formants corresponding to the respective formants when the ratios are larger than a first threshold value;
generating a second formant waveform by multiplying the sinusoidal waveform by the window function of the expanded bandwidth for each of the formant parameter sets; and
generating second pitch-cycle waveforms by the sum of the second formant waveforms.

14. A speech synthesizing method configured to generate speech signals by overlapping pitch-cycle waveforms according to pitch period, comprising steps of:
storing a plurality of formant parameter sets each including at least a formant frequency, a formant phase, and a window function, the spectrum of which indicates the shape of the formant in storage;
selecting the formant parameter set for one frame corresponding to pitch marks from the storage on the basis of pitch-cycle waveform generating data for generating the pitch-cycle waveforms;
generating a sinusoidal waveform according to the formant frequency and the formant phase included in the formant parameter set for each of the formant parameter sets;
generating a first formant waveform by multiplying the sinusoidal waveform by the window function included in the formant parameter set for each of the formant parameter sets;
generating a first pitch-cycle waveform by the sum of the first formant waveforms;
obtaining bandwidth of the respective formants in the spectrum of the first pitch-cycle waveform;
expanding bandwidth of the window functions of the formants corresponding to the respective formants when the bandwidth of the respective formants is narrow;
generating a second formant waveform by multiplying the sinusoidal waveform by the window function of the expanded bandwidth for each of the formant parameter sets; and
generating a second pitch-cycle waveform by the sum of the second formant waveforms.

15. A speech synthesizing method configured to generate speech signals by overlapping pitch-cycle waveforms according to pitch period, comprising steps of:
storing a plurality of formant parameter sets each including at least a formant frequency, a formant phase, and a window function, the spectrum of which indicates the shape of the formant in storage;
selecting the formant parameter set for one frame corresponding to pitch marks from the storage on the basis of pitch-cycle waveform generating data for generating the pitch-cycle waveforms;
generating a sinusoidal waveform according to the formant frequency and the formant phase included in the formant parameter set for each of the formant parameter sets;
generating a first formant waveform by multiplying the generated sinusoidal waveform by the window function included in the formant parameter set for each of the formant parameter sets;
generating a first pitch-cycle waveform by the sum of the first formant waveforms;
obtaining frequency distances of the respective formants in the spectrum of the first pitch-cycle waveform;
expanding bandwidth of the window functions of the formants corresponding to the respective formants when the frequency distances are large;
generating a second formant waveform by multiplying the sinusoidal waveform by the window function of the expanded and compressed bandwidth for each of the formant parameter sets; and
generating a second pitch-cycle waveform by the sum of the second formant waveforms.

16. A sound synthesizing program being stored in a computer readable medium for generating speech signals by overlapping pitch-cycle waveforms according to pitch period, the program realizing functions of:
storing a plurality of formant parameter sets each including at least a formant frequency, a formant phase, and a window function, the spectrum of which indicates the shape of the formant in the storage;
selecting the formant parameter set for one frame corresponding to pitch marks from the storage on the basis of pitch-cycle waveform generating data for generating the pitch-cycle waveforms;
generating a sinusoidal waveform according to the formant frequency and the formant phase included in the formant parameter set for each of the formant parameter sets;
generating a first formant waveform by multiplying the sinusoidal waveform by the window function included in the formant parameter set for each of the formant parameter sets;
generating a first pitch-cycle waveform by the sum of the first formant waveforms;
obtaining ratios of a power at the peak of each formant in a spectrum in the first pitch-cycle waveform with respect to powers at boundaries of the each formant and adjacent formants;
expanding bandwidth of the window functions of the formants corresponding to the respective formants when the ratios are larger than a first threshold value;
generating a second formant waveform by multiplying the sinusoidal waveform by the window function of the expanded bandwidth for each of the formant parameter sets; and
generating a second pitch-cycle waveform by the sum of the second formant waveforms;

17. A speech synthesizing program being stored in a computer readable medium for generating speech signals by overlapping pitch-cycle waveforms according to pitch period, the program realizing functions of:
storing a plurality of formant parameter sets each including at least a formant frequency, a formant phase, and a window function, the spectrum of which indicates the shape of the formant in storage;
selecting the formant parameter set for one frame corresponding to pitch marks from the storage on the basis of pitch-cycle waveform generating data for generating the pitch-cycle waveforms;
generating a sinusoidal waveform according to the formant frequency and the formant phase included in the formant parameter set for each of the formant parameter sets;
generating a first formant waveform by multiplying the sinusoidal waveform by the window function included in the formant parameter set for each of the formant parameter sets;
generating a first pitch-cycle waveform by the sum of the first formant waveforms;
obtaining bandwidth of the respective formants in the spectrum of the first pitch-cycle waveform;
expanding bandwidth of the window functions of the formants corresponding to the respective formants when the bandwidth of the respective formant is narrow;
generating a second formant waveform by multiplying the sinusoidal waveform by the window function of the expanded bandwidth for each of the formant parameter sets; and
generating a second pitch-cycle waveform by the sum of the second formant waveforms;

18. A sound synthesizing program being stored in a computer readable medium for generating speech signals by overlapping pitch-cycle waveforms according to pitch period, the program realizing functions of:
storing a plurality of formant parameter sets each including at least a formant frequency, a formant phase, and a window function, the spectrum of which indicates the shape of the formant in storage;
selecting the formant parameter set for one frame corresponding to pitch marks from a storage on the basis of pitch-cycle waveform generating data for generating the pitch-cycle waveforms;
generating a sinusoidal waveform according to the formant frequency and the formant phase included in the formant parameter set for each of the formant parameter sets;
generating a first formant waveform by multiplying the generated sinusoidal waveform by the window function included in the formant parameter set for each of the formant parameter sets;
generating a first pitch-cycle waveform by the sum of the first formant waveforms;
obtaining frequency distances of the respective formants in the spectrum of the first pitch-cycle waveform;
expanding bandwidth of the window functions of the formants corresponding to the respective formants when the frequency distances are large;
generating a second formant waveform by multiplying the sinusoidal waveform by the window function of the expanded and compressed bandwidth for each of the formant parameter sets; and
generating a second pitch-cycle waveform by the sum of the second formant waveforms.
